(19) United States
(12) Patent Application Publication
(10) Pub. No.: US 2024/0229942 A1
(43) Pub. Date: Jul. 11, 2024

(54) THROTTLE VALVE

(71) Applicant: Stant USA Corp., Connersville, IN (US)

(72) Inventors: George J. Mitri, Connersville, IN (US); John C. Long, Connersville, IN (US); Rick McQuiston, Connersville, IN (US)

(21) Appl. No.: 18/409,287

(22) Filed: Jan. 10, 2024

Related U.S. Application Data
(60) Provisional application No. 63/438,118, filed on Jan. 10, 2023.

(51) Int. Cl. F16K 11/074; F16K 27/04

(52) U.S. Cl. CPC F16K 11/074; F16K 27/045

(57) ABSTRACT

A multi-way valve adapted to control a flow of fluid to different thermal fluid circuits includes a valve housing, a valve flow controller, and a sealing system. The valve flow controller is arranged in the valve housing to control flow through the valve housing. The sealing system is configured to seal between the valve housing and the valve flow controller.

### PRIORITY CLAIM

This application claims priority to and the benefit of U.S. Provisional Patent Application No. 63/438,118, filed 10 Jan. 2023, the disclosure of which is now expressly incorporated herein by reference.

### TECHNICAL FIELD

The present disclosure relates to multi-way valves, and particularly to multi-way valves for controlling the flow of heating and/or cooling fluid to various thermal fluid circuits in a vehicle. More particularly, the present disclosure relates to an electro mechanical multi-way valve.

### BACKGROUND

Multi-way valves are used for controlling the flow of fluid to various thermal fluid circuits in a vehicle. However, there is a need for multi-way valves with an increased number of possible flow paths and improved sealing.

### SUMMARY

The present disclosure provides a multi-way valve that controls the flow of heating and/or cooling fluid to different thermal fluid circuits in a vehicle with improved sealing. The multi-way valve may include a valve housing and a valve flow controller positioned in the housing to control the flow of fluid through the valve housing. The flow of heating and/or cooling fluid may be controlled to direct fluid to different thermal fluid circuits in a vehicle.

According to an aspect of the present disclosure, the valve housing may include a valve housing body coupled to a manifold of the thermal fluid circuits and a housing end cover. The valve housing body may be shaped to define a valve cavity and a plurality of apertures that open into the valve cavity. The housing end cover may be coupled to the second end of the valve housing to close a second end opening to the valve cavity.

According to an aspect of the present disclosure, the valve flow controller may include a valve rotor arranged in the valve cavity of the valve housing body. The valve rotor may each be configured to rotate relative to the valve housing body about a valve axis. The valve rotor may cooperate with the valve housing to define a plurality of flow paths in the valve housing when the valve rotor is rotated about the valve axis to control the flow of fluid through the valve housing.

According to an aspect of the present disclosure, the valve flow controller of the multi-way valve may further include an actuator coupled to the valve rotor to control rotation of the valve rotor about the axis. The actuator may rotate the valve rotor to different predetermined positions relative to the valve housing to establish different flow paths through the housing.

According to an aspect of the present disclosure, the multi-way vale may further include a sealing system configured to form a seal engagement between the valve rotor and the valve housing body of the valve housing. The sealing system may include a seal that is located in an inlet aperture formed in the valve housing body.

According to an aspect of the present disclosure, the sealing system may further include a biasing assembly configured to apply an axial force on the valve rotor when the valve rotor is in preselected positions relative to the valve housing body. The biasing assembly may selectively apply the axial force to the valve rotor to urge the valve rotor into a predetermined level of engagement with the seal when the valve rotor is in one of the different preselected positions.

With the multi-way valve of the present disclosure, a multi-way valve with an increased number of flow paths and improved sealing is provided. The valve rotor may be rotated about the valve axis and cooperate with the valve housing to define the increased number of flow paths. This arrangement improves sealing between the aperture in the valve housing body not only because the flow path is less complicated, but the sealing system also uses less material for the seal and reduces the friction on the valve rotor. The increased engagement of the valve rotor with the corresponding seal also improves sealing between the valve rotor and the valve housing body and reduces leakage therebetween. This increased engagement of the valve rotor with the corresponding seal applied only at preselected positions also reduces the amount of torque needed to rotate the valve rotor between various positions and reduces wear on the seals themselves.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective diagrammatic view of a multi-way valve configured to control the flow of fluid to various thermal fluid circuits in a vehicle;

FIG. 2 is an exploded view of the multi-way valve of FIG. 1 showing the multi-way valve includes a valve housing, a valve flow controller having a valve rotor—also referred to as a throttle valve rotor—configured to be arranged in a valve cavity of the valve housing to control a flow of fluid through the valve housing and an actuator coupled to the valve rotor to rotate the valve rotor about a valve axis, and a sealing system configured to seal between valve rotor of the valve flow controller and the valve housing;

FIG. 3 is an exploded view of the multi-way valve of FIG. 1 showing the valve housing includes a valve housing body shaped to define a valve cavity and a plurality of apertures that open into the valve cavity and a housing end cover configured to be coupled to an open end of the valve housing body to close an end opening to the valve cavity with the valve rotor arranged in the valve cavity;

FIG. 4 is an exploded view of the valve housing body and the valve flow controller included in the multi-way valve of FIG. 2 with a portion of the valve housing broken away to show the valve housing body includes an annular outer wall that extends around the valve axis to define the valve cavity, a housing base that extends from the annular outer wall and formed to define the plurality of apertures that extend radially through the housing base relative to the valve axis, and an end wall opposite the housing end cover formed to include an inlet aperture that opens into the cavity;

FIG. 5 is a perspective view of the valve rotor and the housing end cover included in the multi-way valve of FIG. 2 showing the valve rotor includes a valve rotor plate, a plurality of valve rotor walls that extend axially away from the valve rotor plate and spaced apart circumferentially to define a plurality of valve ports, and a valve shaft that extends axially from the valve rotor plate through the housing end cover of the valve housing to a terminal end located outside the housing end cover and coupled to the actuator, and further showing the valve rotor plate is formed to include a rotor through hole that extends axially through the valve rotor relative to the valve axis so that the flow of fluid is able to flow axially through the valve rotor parallel to the valve axis;

FIG. 6 is an elevation view of the valve rotor of FIG. 5 showing the cam surfaces included in the biasing assembly each form a high point that when aligned with the cam ramps on the housing end cover apply the axis force to the valve rotor, and further showing each of the cam surfaces is formed on the terminal ends of each valve rotor wall such that the high point of each cam surface is not equally spaced apart around the valve axis;

FIG. 7 is an elevation view of the housing end cover of FIG. 5 showing the camp ramps are equally spaced apart around the valve axis and each of the cam ramps forms a high point that engages with the high point on the cam surfaces to apply the axial force;

FIG. 8 is a table showing the different modes of the multi-way valve of FIG. 1 and the different flow paths created at each of the different modes A-E;

FIG. 9 is a cross-sectional view of the multi-way valve of FIG. 1 with the valve rotor in a VALVE ROTOR FIRST position in which the inlet aperture formed in the end wall of the valve housing body is blocked by the valve rotor and the first aperture and the second aperture formed in the valve housing body are in fluid communication with the valve cavity and with each other;

FIG. 10 is a cross-sectional view of the multi-way valve of FIG. 1 with the valve rotor in a VALVE ROTOR SECOND position in which the valve rotor covers the first aperture and the hole formed in the valve rotor is aligned with the inlet aperture so that the inlet aperture is in fluid communication with the second aperture;

FIG. 11 is a cross-sectional view of the multi-way valve of FIG. 1 with the valve rotor in a THROTTLE configuration in which the hole formed in the valve rotor remains aligned with the inlet aperture so that the inlet aperture is in fluid communication with both the first aperture and the second aperture formed in the valve housing body;

FIG. 12 is a cross-sectional view of the multi-way valve of FIG. 1 with the valve rotor in a VALVE ROTOR THIRD position in which the inlet aperture, the first aperture, and the second aperture are all blocked by the valve rotor so that the valve cavity is isolated from the inlet aperture, the first aperture, and the second aperture and the apertures are isolated from each other;

FIG. 13 is a cross-sectional view of the multi-way valve of FIG. 1 with the valve rotor in a VALVE ROTOR FOURTH position in which the valve rotor covers the second aperture and the hole formed in the valve rotor is aligned with the inlet aperture so that the inlet aperture is in fluid communication with the first aperture;

FIG. 14 is a cross-sectional view of the multi-way valve of FIG. 1 showing the valve housing body may further include an inlet pipe that defines a passageway that opens to the inlet aperture in the end wall of the valve housing body;

FIG. 15 is a cross-sectional view of a portion of the multi-way valve of FIG. 1 showing the biasing assembly has not yet applied the axial force to the valve rotor;

FIG. 15A is a detail view of FIG. 15 showing one of the cam surfaces on the valve rotor is spaced apart from the corresponding cam ramp so that the axial force is not applied to the valve rotor by the biasing assembly to reduce friction on the valve rotor as the valve rotor rotates about the valve axis;

FIG. 16 is a cross-sectional view similar to FIG. 15 showing the valve rotor has rotated about the valve axis to one of the predetermined positions to cause the biasing assembly to apply the axial force to the valve rotor to urge the valve rotor axially toward the partition wall of the valve housing and into engagement with the seal to increase friction therebetween; and

FIG. 16A is a detail view of FIG. 16 showing the cam surface on the valve rotor is aligned with the corresponding cam ramp so that the axial force is applied to the valve rotor by the biasing assembly to increase friction on the valve rotor and improve sealing.

### DETAILED DESCRIPTION

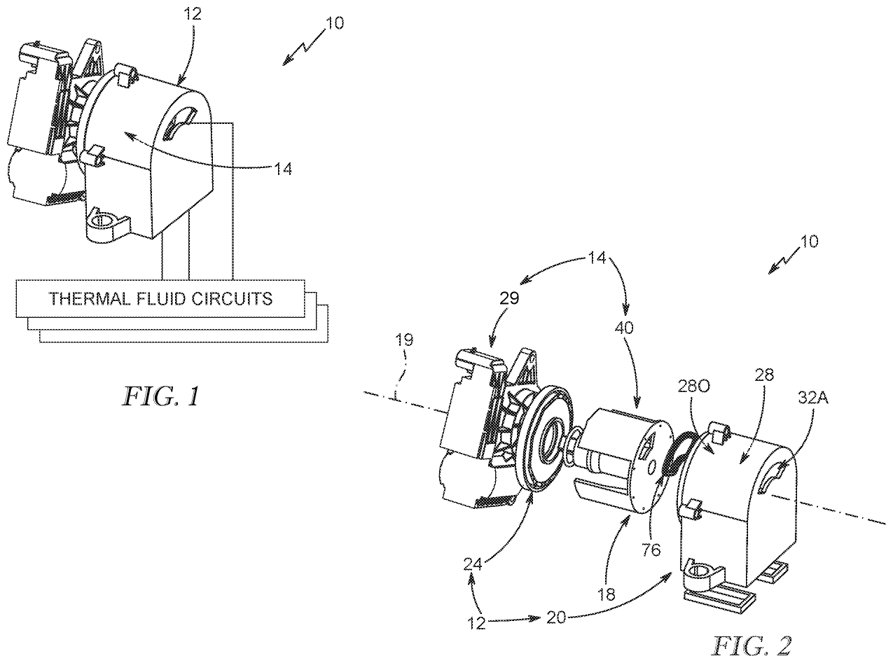

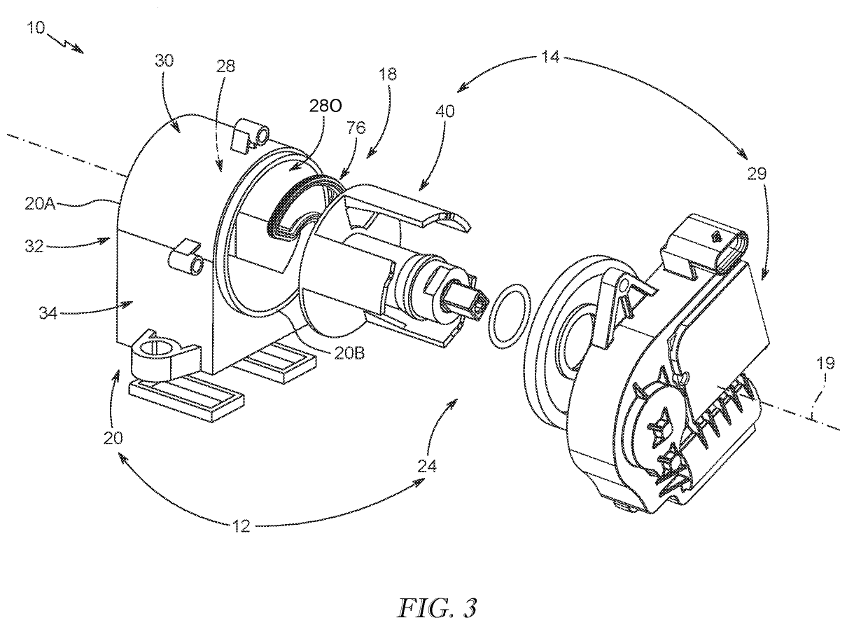

An illustrative multi-way valve 10 configured to control the flow of fluid to various thermal fluid circuits in a vehicle is shown in FIG. 1. The multi-way valve 10 includes a valve housing 12, a valve flow controller 14, and a sealing system 18 as shown in FIGS. 2 and 3. The valve flow controller 14 is arranged in the valve housing 12 to control flow through the valve housing 12. The sealing system 18 is configured to seal between the valve housing 12 and the valve flow controller 14.

The valve flow controller 14 includes a valve rotor 40 arranged in a valve cavity 28 formed by the valve housing 12 and an actuator 29 as shown in FIGS. 2 and 3. The valve rotor 40 is configured to rotate relative to the valve housing 12 about a valve axis 19. The actuator 29 is coupled to the valve rotor 40 to drive rotation of the valve rotor 40.

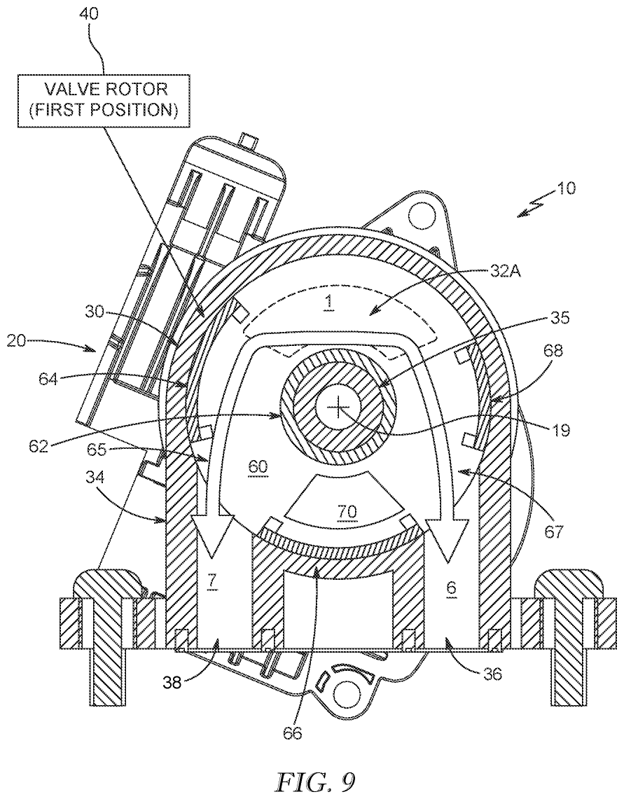

The valve rotor 40 cooperates with the valve housing 12 to define a plurality of flow paths through the valve housing 12 as shown in FIGS. 9-13. As the valve rotor 40 is rotated about the valve axis 19 to different set positions as shown in FIGS. 9-13, the valve rotor 40 forms the different flow paths to control a flow of fluid through the valve housing 12 to different thermal fluid circuits.

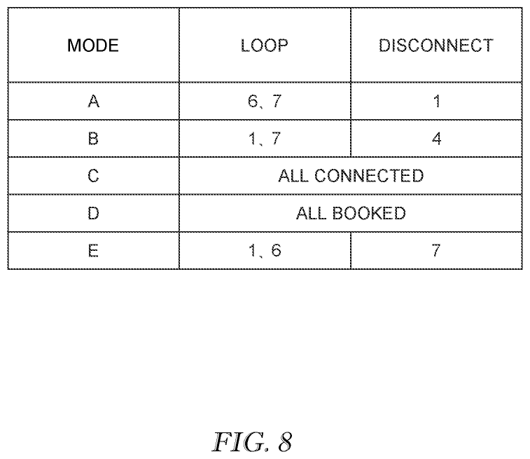

The different modes of the multi-way valve 10 are shown in FIG. 8. The valve rotor 40 is in different predetermined positions in each of the different modes A-E to form the different flow paths through the valve housing 12. The multi-way valve 10 and/or the actuator 29 may include a control unit that is preprogrammed with the different modes A-E.

The arrangement and shape of the valve rotor 40 in the valve housing 12 reduces the overall size of the multi-way valve 10 compared to other multi-way valves and improves sealing between the valve rotor 40 and the valve housing 12. Other multi-way valves may have more complex passageways through the valve housing, which complicates sealing and increases the pressure drop as the fluid has to make more turns/changes direction more. The complex passageways may increase the potential for leaks across the different passageways. These valves may incorporate seals to seal between the passageways, but adding seals may require the actuator to have an increased torque capability to overcome the friction of the seals between the different components.

Moreover, adding more seals increases the overall manufacturing cost of the multi-way valve. Some valves may use a Teflon material for the seals. This may make manufacturing a multi-way valve expensive, especially as other valves have complex passageways with large, complex seals that may need large amounts of Teflon material.

The multi-way valve 10 of the present disclosure includes a single valve rotor 40 that cooperates with the valve housing 12 to form a plurality of flow paths. The arrangement of the valve rotor 40 reduces the amount of sealing material and improves sealing. Additionally, the arrangement of the valve rotor 40 reduces the contract surface area of the seal 76, thereby reducing the friction on the valve rotor 40.

Turning again to the valve housing 12, the valve housing includes a valve housing body 20 and a housing end cover 24 as shown in FIGS. 2-4. The valve housing body 20 is formed to include the valve cavity 28 and a plurality of apertures 36, 38 that open into the valve cavity 28. The housing end cover 24 is coupled to a second end 20B of the valve housing body 20 to close an end opening 280 to the valve cavity 28.

In some embodiments, the valve housing 12 may further include any one of a quick connect, push lock, barb, pipe, port, etc. that define the apertures 36, 38. In some embodiments, any outlet aperture may be defined by one of a quick connect, push lock, barb, pipe, port, etc.

The valve housing body 20 includes an annular outer wall 30, an end wall 32, and a housing base 34 as shown in FIGS. 2-4. The annular outer wall 30 extends around the valve axis 19 to define the valve cavity 28. The end wall 32 forms a first end 20A of the valve housing body 20 that is spaced apart axially from the second end 20B of the valve housing body 20 relative to the valve axis 19. The housing base 34 extends away from the outer wall 30 and is formed to define the plurality of apertures 36, 38 that open in the valve cavity 28.

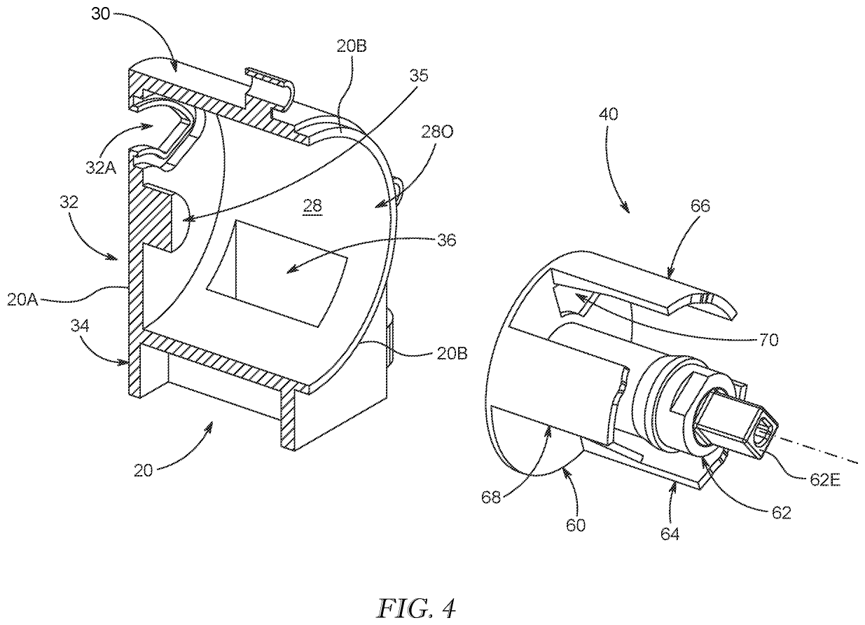

The end wall 32 is formed to include an aperture 32A as shown in FIGS. 3 and 4. The aperture 32A, also referred to as the inlet aperture 32A, extends axially through the end wall 32. The aperture 32A extends circumferentially partway about the valve axis 19.

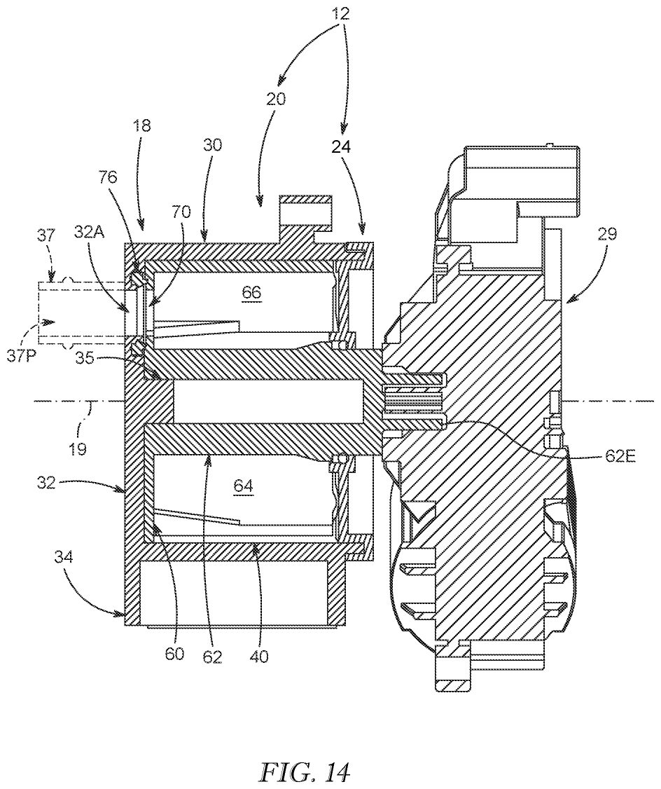

The aperture 32A is an inlet port in the illustrative embodiment. In some embodiments, the valve housing 12 may include an inlet pipe 37 as suggested in FIG. 14. The inlet pipe 37 may be a quick connect, barb, etc. and the inlet pipe 37 may define a passageway 37P and the aperture 32A forms the inlet port to the valve cavity 28.

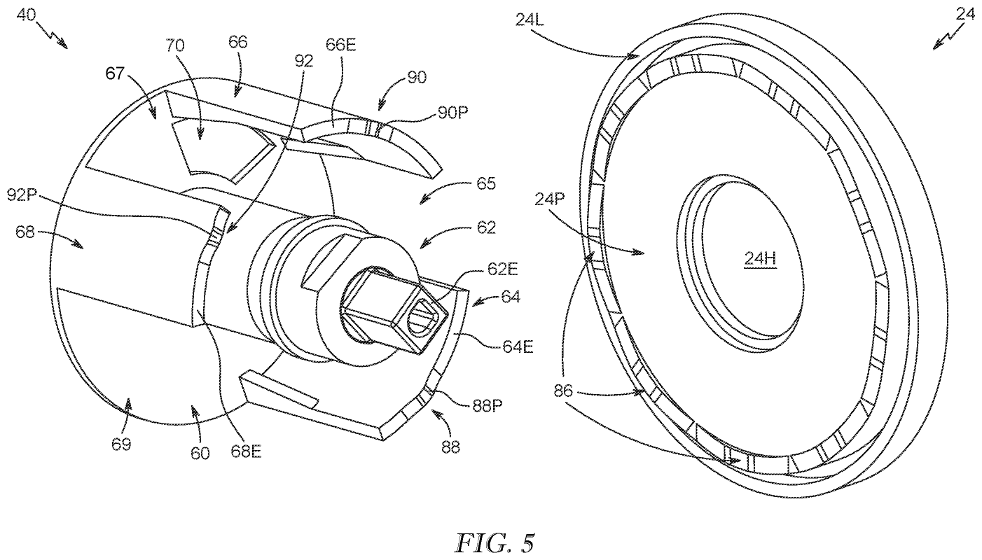

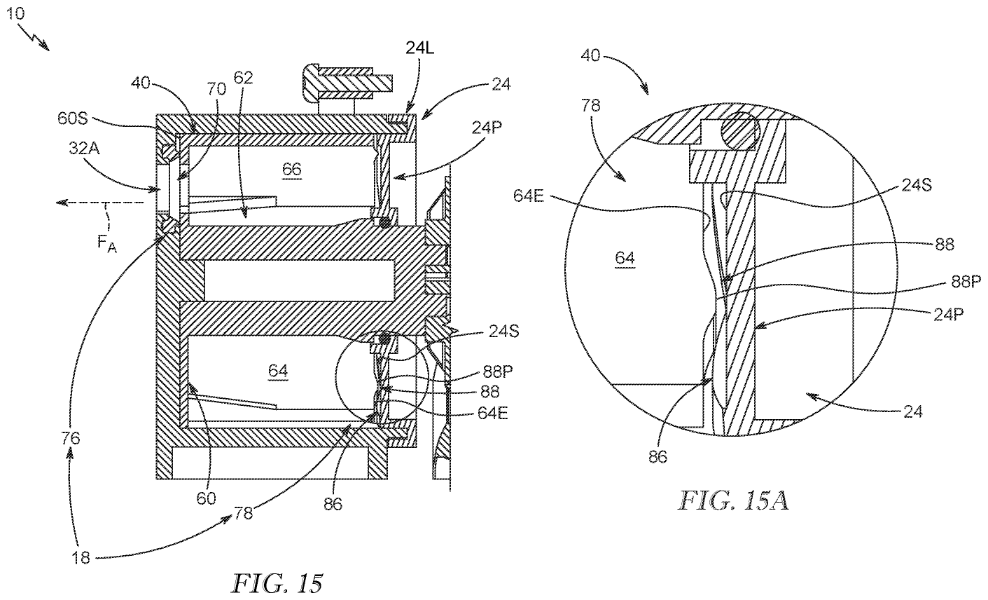

In the illustrative embodiment, the valve housing body 20 is also formed to include a rod 35 as shown in FIGS. 5 and 15. The rod 35 extends axially away from the end wall 32 into the valve cavity 28. The rod 35 is aligned with the valve axis 19. The rod 35 extends into the valve rotor 40 to provide support for one end of the valve rotor 40. In the illustrative embodiment, the aperture 32A is located radially outward of the rod 35.

The plurality of apertures 36, 38 includes a first aperture 36 and a second aperture 38 as shown in FIGS. 9-14. The first aperture 36 and the second aperture 38 open into the valve cavity 28.

In the illustrative embodiment, there is no seal between the valve rotor 40 and the valve housing 12 at the first and second apertures 36, 38, but there is a seal 76 in the aperture 34A. In other embodiments, another seal may be located between the valve rotor 40 and the valve housing 12 at the first and second apertures 36, 38. That seal may extend around the apertures 36, 38.

In the illustrative embodiment, the seal 76 is a press-fit seal. In some embodiments, the seal 76 may be over molded. In some embodiments, the seal 76 may be an o-ring. In other embodiments, the seal 76 may be any other suitable seal.

The housing end cover 24 includes a cover plate 24P that extends circumferentially around the valve axis 19 as shown in FIGS. 3 and 4. The cover plate 24P couples to the second end 20B of the valve housing body 20. In the illustrative embodiment, an outer edge of the cover plate 24P forms a lip 24L that extends around the second end 20B of the valve housing body 20 to couple the housing end cover 24 to the valve housing body 20. The cover plate 24P is also formed to include a hole 24H that extends axially therethrough and receives a portion of the valve rotor 40.

The valve flow controller 14 includes the valve rotor 40. The valve rotor 40 is arranged in the valve cavity 28 of the valve housing body 20. The valve rotor 40 is configured to rotate relative to the valve housing body 20 about the valve axis 19.

The valve rotor 40 cooperates with the valve housing 12 to define a plurality of flow paths through the valve housing body 20. As the valve rotor 40 is rotated about the valve axis 19 to different set positions, the valve rotor 40 forms different flow paths to control the flow of fluid through the apertures 32A, 36, 38 of the valve housing body 20.

The valve rotor 40 includes a valve rotor plate 60, a valve shaft 62, and a plurality of valve rotor walls 64, 66, 68 as shown in FIGS. 7 and 8. The valve rotor plate 60 extends circumferentially about the valve axis 19. The valve shaft 62 extends axially away from the valve rotor plate 60 to a terminal end 62E. The valve shaft 62 extends through the housing end cover 24 to so that the terminal end 62E is located outside of the housing end cover 24. Each of the valve rotor walls 64, 66, 68 extend axially away from the valve rotor plate 60 in the same direction as the valve shaft 62. The valve rotor walls 64, 66, 68 are spaced apart circumferentially to define a plurality of valve rotor ports 65, 67, 69

In the illustrative embodiment, the valve shaft 62 is hollow as shown in FIGS. 5 and 15. The rod 35 extends axially from the end wall 32 into the valve shaft 62 to support the valve rotor 40 relative to the valve housing body 20.

The valve rotor plate 60 is formed to define a through hole 70 as shown in FIGS. 7 and 8. The through hole 70 extends axially through the valve rotor plate 60 relative to the valve axis 19 so that the flow of fluid is able to flow axially through the valve rotor 40 parallel to the valve axis 19. The through hole 70 extends circumferentially partway about the valve axis 19 in the illustrative embodiment.

Each of the valve rotor walls 64, 66, 68 extends axially away from the valve rotor plate 60 to a terminal end 64E, 66E, 68E as shown in FIGS. 7 and 8. The terminal ends 64E, 66E, 68E of each of the valve rotor walls 64, 66, 68 is spaced apart axially from the terminal end 62E of the valve shaft 62 such that the valve rotor walls 64, 66, 68 do not extend past the housing end cover 24.

As the valve rotor 40 rotates, the valve rotor plate 60 controls the flow of fluid through the aperture 32A, while the valve rotor walls 64, 66, 68 vary the amount of fluid flowing through the apertures 36, 38 formed in the valve housing body 20 as shown in FIGS. 9-14. The different valve rotor walls 64, 66, 68 partially open, fully open, or close the apertures 36, 38 in the different predetermined positions to control the flow of fluid therethrough. In some positions, a portion of the valve rotor plate 60 covers the aperture 32A to block the flow of fluid therethrough.

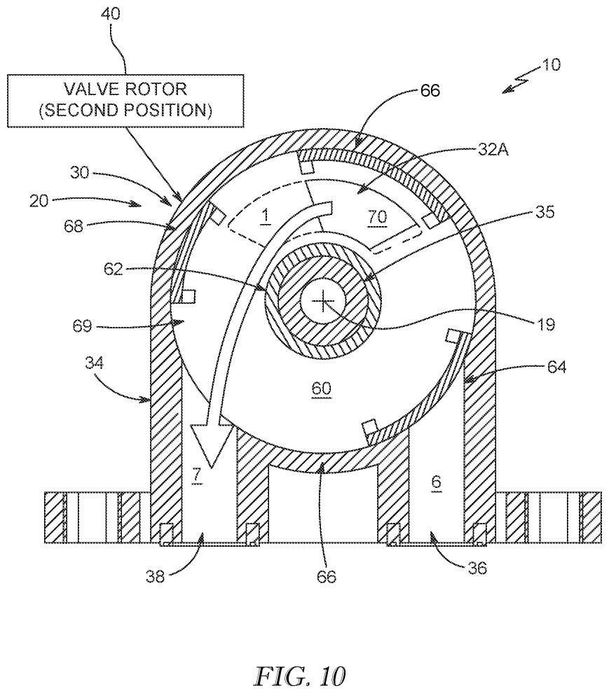

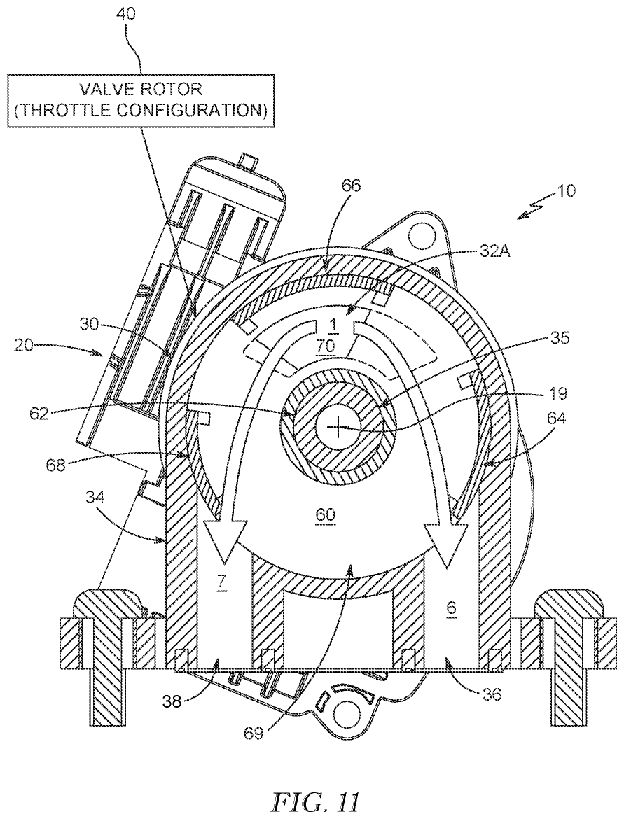

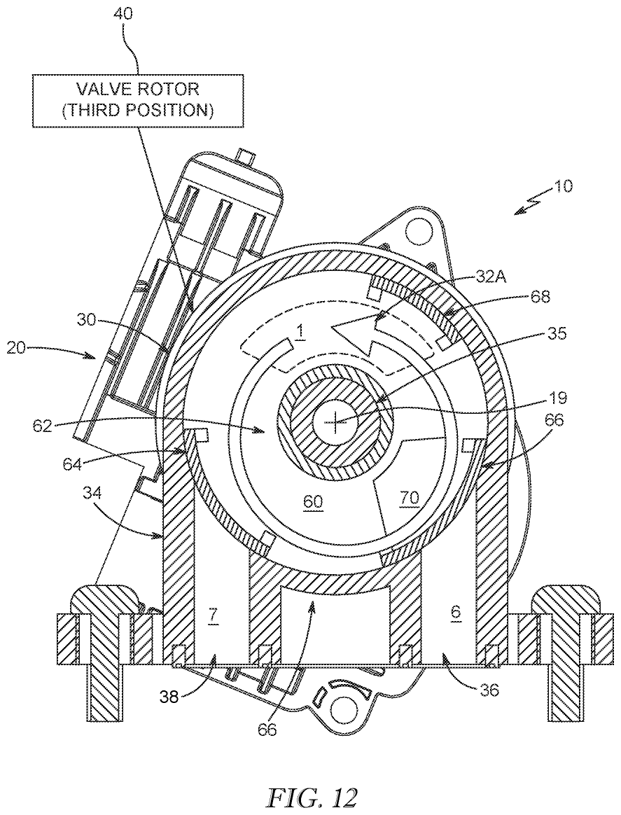

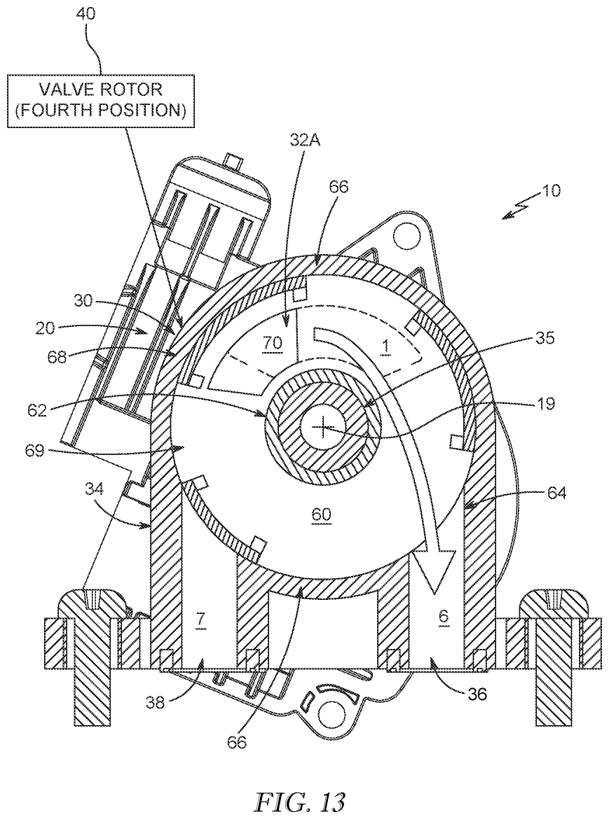

The different modes of the multi-way valve 10 are shown in FIG. 8. The first mode (mode A) is shown in FIG. 9. The second mode (mode B) are shown in FIG. 10. The third mode (mode C) is shown in FIG. 11. The fourth mode (mode D) is shown in FIG. 12. The fifth mode (mode E) is shown in FIG. 13.

In mode A, the valve rotor 40 is in a VALVE ROTOR FIRST position as shown in FIG. 9. In the VALVE ROTOR FIRST position, the valve rotor 40 covers the aperture 32A to block flow through the aperture 32A formed in the end wall 32 and connects the first aperture 36 and the second aperture 38. The valve rotor ports 65, 67 align with the first and second apertures 36, 38 to allow the flow of fluid between the first aperture 36 and the second aperture 38.

In mode B, the valve rotor 40 moves to a VALVE ROTOR SECOND position as shown in FIG. 10. In the VALVE ROTOR SECOND position, the valve rotor 40 has rotated about the valve axis 19 to uncover the aperture 32A to align the hole 70 with the aperture 32A. This allows flow through the aperture 32A formed in the end wall 32 and the hole 70. Simultaneously, one of the valve rotor walls 64 covers the first aperture 36 to block flow through the first aperture 36, while one of the valve rotor ports 69 aligns with the second aperture 38. In this way, the second aperture 38 is in fluid communication with the first aperture 36A.

In mode C, the valve rotor 40 moves to a THROTTLE configuration as shown in FIG. 11. In the THROTTLE configuration, the valve rotor 40 has rotated to uncover the first aperture 36, while keeping the hole 70 formed in the valve rotor 40 aligned with the aperture 32A. In the THROTTLE configuration, the valve rotor port 69 aligns with both the first aperture 36 and the second aperture 38 to allow the flow of fluid therethrough. However, in the THROTTLE configuration, the valve rotor 40 can rotate about the valve axis 19 to vary, or throttle, the flow through the first and second apertures 36, 38. The valve rotor walls 64, 68 may block a portion of the corresponding aperture 36, 38 to vary the flow therethrough.

In mode D, the valve rotor 40 is in a VALVE ROTOR THIRD position as shown in FIG. 12. In the VALVE ROTOR THIRD position, the valve rotor 40 has rotated about the valve axis 19 to cover each of the apertures 32A, 36, 38. The valve rotor 40 covers the aperture 32A to block flow through the aperture 32A formed in the end wall 32 and the valve rotor walls 64, 66 block the corresponding apertures 36, 38. The valv rotor walls 64, 66 each align with the corresponding aperture 36, 38 to block the flow of fluid therethrough. In this way, the valve cavity 28 is isolated so that now flow of fluid flows out of the valve cavity 28.

In mode E, the valve rotor 40 is in a VALVE ROTOR FOURTH position as shown in FIG. 13. In the VALVE ROTOR FOURTH position, the valve rotor 40 has rotated about the valve axis 19 to uncover the aperture 32A to at least partially align the hole 70 with the aperture 32A. This allows flow through the aperture 32A formed in the end wall 32 and the hole 70. Simultaneously, one of the valve rotor walls 68 covers the second aperture 38 to block flow through the second aperture 38, while one of the valve rotor ports 69 aligns with the first aperture 36. In this way, the first aperture 36 is in fluid communication with the aperture 32A.

The multi-way valve 10 and/or the actuator 29 may include the control unit configured to direct the actuator 29 to move the valve rotor 40 to the different predetermined positions in each of the different modes A-E. Based on where the vehicle needs fluid, the control unit would direct the actuator 29 to move the valve rotor 40 to one of the positions for the desired mode.

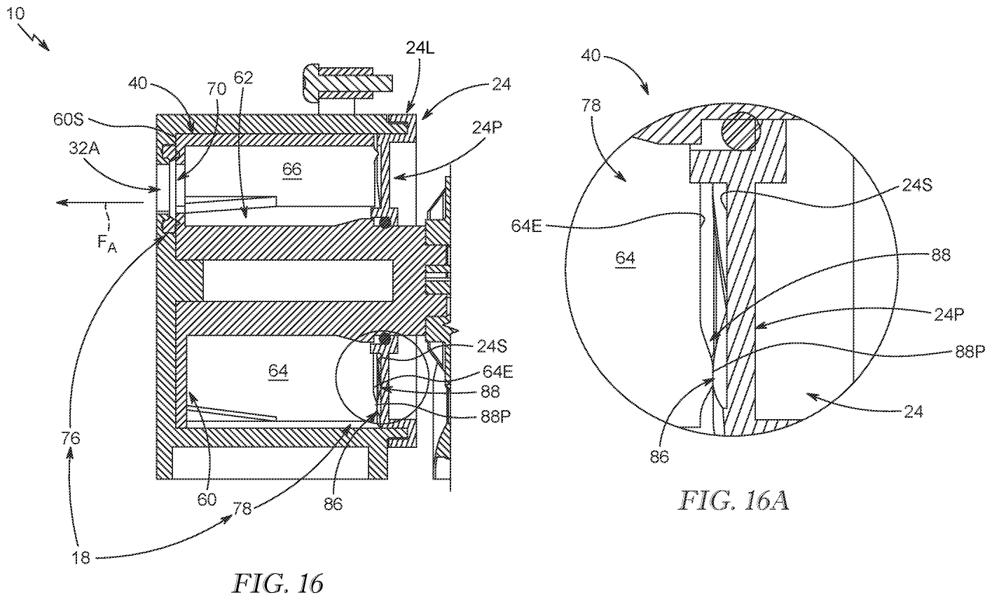

The sealing system 18 help seal between the valve housing 12 and the valve rotor 40 in the different predetermined positions as shown in FIGS. 15-16A. The sealing system 18 seals between the end wall 32 of the valve housing body 20 and the valve rotor 40 in the illustrative embodiment.

The sealing system 18 includes a seal 76 and a biasing assembly 78 as shown in FIGS. 15-16A. The seal 76 is located in the aperture 32A formed in the end wall 32 of the valve housing body 20 to engage an axially facing surface 60S of the valve rotor 40. In the illustrative embodiment, the seal 76 is press fit into the aperture 32A formed in the end wall 32 of the valve housing body 20 to engage an axially facing surface 60S of the valve rotor 40. The biasing assembly 78 is configured to selectively apply an axial force FA on the valve rotor 40 to urge the valve rotor 40 toward the end wall 32 of the valve housing body 20, i.e. away from the housing end cover 24, when the valve rotor 40 is in one of the plurality of different predetermined positions so as to increase sealing between the valve rotor 40 and the valve housing body 20. The axial force FA is applied to urge the valve rotor 40 into engagement with the seal 76 when the valve rotor 40 is in one of the plurality of different predetermined positions to improve sealing between the valve rotor 40 and the end wall 32 of the valve housing body 20.

The biasing assembly 78 selectively applies the axial force FA to increase friction between the valve rotor 40 and the seal at the different predetermined positions, but removes the axial force FA when the valve rotor 40 rotates to reduce the friction between the valve rotor 40 and the seal 76. In this way, the torque needed to rotate the valve rotor 40 is reduced and the wear on the seal 76 is reduced.

In the illustrative embodiment, the seal 76 comprises a Teflon material. In some embodiments, the seals may be made of another suitable material.

In other multi-way seals, large amounts of Teflon material may be used to seal the different passages, which can make manufacturing the multi-way valve expensive. Therefore, by reducing the amount of friction on the seal 76 during rotation of the valve rotor 40, wear on the seal 76 is reduced. This reduces the need to replace the seal 76 as well and reduces the cost of repairing the multi-way valve 10. In other embodiments, the seals may be made of another suitable material.

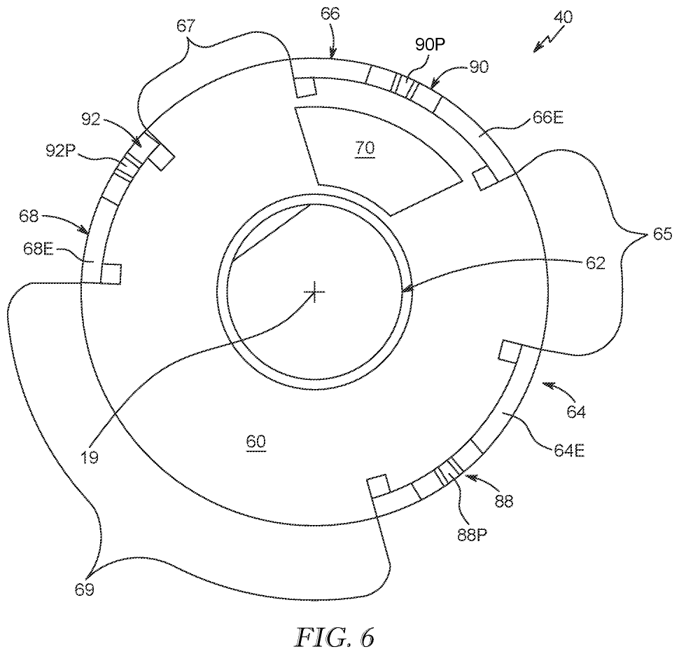

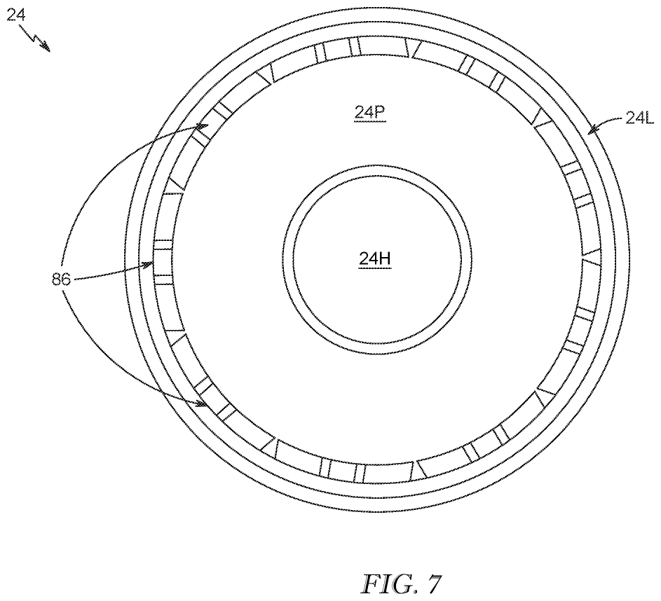

The biasing assembly 78 includes cam ramps 86 and a plurality of cam surfaces 88, 90, 92 as shown in FIGS. 5-7 and 15-16A. The cam ramps 86 are formed on an axially facing 24S surface of the housing end cover 24 of the valve housing body 20. The cam ramps 86 are equally spaced apart circumferentially about the valve axis 19. Each cam surface 88, 90, 92 is formed on one of the valve rotor walls 64, 66, 68. The cam surfaces 88, 90, 92 are configured to engage the cam ramps 86 on the housing end cover 24 as the valve rotor 40 rotates about the valve axis 19 to the plurality of different predetermined positions.

In this way, the raised portions 88P, 90P, 92P of each of the cam surfaces 88, 90, 92 engages one of the cam ramps 86 in each of the different predetermined positions to cause the axial force FA to be applied to the valve rotor 40. Then as the valve rotor 40 rotates about the valve axis 19, the raised portions 88P, 90P, 92P of the cam surfaces 88, 90, 92 disengage the cam ramps 86 so that the axial force FA is removed and the torque needed to rotate the valve rotor 40 is reduced.

The cam ramps 86 are fixed on the housing end cover 24. The cam surfaces 88, 90, 92 on the valve rotor 40 rides against the cam ramps 86 in a circular manner and applies downward axial force FA to the valve rotor 40 when aligned with the high point 88P, 90P, 92P of the cam surfaces 88, 90, 92. This force FA generates a contact pressure between the underside of the valve rotor 40 and the elastomer seal 76 press-fit into the end wall 32 of the valve housing body 20. The increased contact pressure and resulting increase in friction are only generated when each high point 88P, 90P, 92P of the cam surfaces 88, 90, 92 is aligned with a cam ramp 86. This reduces friction and torque on the actuator 29 during movement between seal points.

1. A multi-way valve comprising
a valve housing coupled to a manifold of thermal fluid circuits, the valve housing including a valve housing body and a housing end cover coupled to a first end of the valve housing body, the valve housing body shaped to define a valve cavity and a plurality of apertures that open into the valve cavity, and the housing end cover coupled to the first end of the valve housing to close an end opening to the valve cavity, and
a valve flow controller includes a valve rotor arranged in the valve cavity of the valve housing body and configured to rotate relative to the valve housing body about a valve axis and an actuator coupled to the valve rotor to drive rotation of the valve rotor about the valve axis,
wherein the valve rotor cooperates with the valve housing to define a plurality of flow paths when the valve rotor is rotated about the valve axis to a plurality of different predetermined positions to control a flow of fluid through the valve housing,
wherein the valve housing body includes an annular outer wall that extends around the valve axis to define the valve cavity, a housing base that extends from the annular outer wall and formed to define the plurality of apertures that extend radially through the housing base relative to the valve axis, and an end wall opposite the housing end cover formed to include an inlet aperture that extends axially through the end wall and opens into the valve cavity.

2. The multi-way valve of claim 1, wherein the inlet aperture extends circumferentially partway about the valve axis.

3. The multi-way valve of claim 1, wherein the valve rotor includes a valve rotor plate, a plurality of valve rotor walls that extend axially away from the valve rotor plate and spaced apart circumferentially to define a plurality of valve ports, and a valve shaft that extends axially from the valve rotor plate through the housing end cover of the valve housing to a terminal end located outside the housing end cover and coupled to the actuator, and wherein the valve rotor plate is formed to include a rotor through hole that extends axially through the valve rotor relative to the valve axis so that the flow of fluid is able to flow axially through the valve rotor parallel to the valve axis.

4. The multi-way valve of claim 3, further comprising a sealing system configured to seal between the valve rotor and the valve housing body, the sealing system including a seal located in the inlet aperture formed in the end wall of the valve housing body to engage an axially facing surface of the valve rotor.

5. The multi-way valve of claim 4, wherein the sealing system further includes biasing means for applying an axial force on the valve rotor to urge the valve rotor into engagement with the seal when the valve rotor is in one of the plurality of different predetermined positions to improve sealing between the valve rotor and the end wall of the valve housing body and for removing the axial force on the valve rotor to reduce friction between the valve rotor and the seal when the valve rotor is rotated about the valve axis from one position to another position included in the plurality of different predetermined positions.

6. The multi-way valve of claim 5, wherein the biasing means includes cam ramps on an axially facing surface of the housing end cover of the valve housing and a plurality of cam surfaces on the valve rotor configured to engage the cam ramps on the housing end cover as the valve rotor rotates about the valve axis to the plurality of different predetermined positions.

7. The multi-way valve of claim 4, wherein the seal comprises Teflon material.

8. The multi-way valve of claim 1, further comprising a sealing system configured to seal between the valve rotor and the valve housing body, the sealing system including a seal located in the inlet aperture formed in the end wall of the valve housing body to engage an axially facing surface of the valve rotor and a biasing assembly configured to selectively apply an axial force on the valve rotor to urge the valve rotor into engagement with the seal when the valve rotor is in one of the plurality of different predetermined positions to improve sealing between the valve rotor and the valve housing body.

9. The multi-way valve of claim 8, wherein the biasing assembly includes cam ramps on an axially facing surface of the housing end cover of the valve housing and a plurality of cam surfaces on the valve rotor configured to engage the cam ramps on the housing end cover as the valve rotor rotates about the valve axis to the plurality of different predetermined positions.

10. The multi-way valve of claim 8, wherein the seal comprises Teflon material.

11. The multi-way valve of any one of claim 1, wherein the multi-way valve further comprises a sealing system configured to seal between the valve rotor and the valve housing body, the sealing system including a biasing assembly configured to selectively apply an axial force on the valve rotor to urge the valve rotor toward the valve rotor when the valve rotor is in one of the plurality of different predetermined positions to increase sealing between the valve rotor and the valve housing body.

12. The multi-way valve of claim 11, wherein the biasing assembly includes cam ramps on an axially facing surface of the housing end cover of the valve housing and a plurality of cam surfaces on the valve rotor configured to engage the cam ramps on the housing end cover as the valve rotor rotates about the valve axis to the plurality of different predetermined positions.

13. A multi-way valve comprising
a valve housing including a valve housing body that extends axially along a valve axis and a housing end cover coupled to a first end of the valve housing body, the valve housing body shaped to define a valve cavity and a plurality of apertures that open into the valve cavity, and the housing end cover coupled to the first end of the valve housing to close an end opening to the valve cavity,
a valve flow controller includes a valve rotor arranged in the valve cavity of the valve housing body and configured to rotate relative to the valve housing body about the valve axis and an actuator coupled to the valve rotor to drive rotation of the valve rotor about the valve axis, and the valve rotor cooperates with the valve housing to define a plurality of flow paths when the valve rotor is rotated about the valve axis to a plurality of different predetermined positions to control a flow of fluid through the valve housing, and
a sealing system configured to seal between the valve rotor and the valve housing body, the sealing system including a biasing assembly configured to selectively apply an axial force on the valve rotor to urge the valve rotor away from the housing end cover when the valve rotor is in one of the plurality of different predetermined positions to increase sealing between the valve rotor and the valve housing body.

14. The multi-way valve of claim 13, wherein the biasing assembly includes cam ramps on an axially facing surface of the valve housing and a plurality of cam surfaces on the valve rotor configured to engage the cam ramps on the valve housing as the valve rotor rotates about the valve axis to the plurality of different predetermined positions.

15. The multi-way valve of claim 13, wherein the sealing system further includes a seal located axially between the valve rotor and the valve housing.

16. The multi-way valve of claim 15, wherein the valve housing body includes an annular outer wall that extends around the valve axis to define the valve cavity, a housing base that extends from the annular outer wall and formed to define the plurality of apertures that extend radially through the housing base relative to the valve axis, and an end wall opposite the housing end cover formed to include an inlet aperture that opens into the valve cavity, and the seal is located in the inlet aperture formed in the end wall.

17. The multi-way valve of claim 13, wherein the valve rotor includes a valve rotor plate, a plurality of valve rotor walls that extend axially away from the valve rotor plate and spaced apart circumferentially to define a plurality of valve ports, and a valve shaft that extends axially from the valve rotor plate through the housing end cover of the valve housing to a terminal end located outside the housing end cover and coupled to the actuator, and wherein the valve rotor plate is formed to include a rotor through hole that extends axially through the valve rotor relative to the valve axis so that the flow of fluid is able to flow axially through the valve rotor parallel to the valve axis.

18. The multi-way valve of claim 17, wherein the biasing assembly includes cam ramps on an axially facing surface of the valve housing and a plurality of cam surfaces on each valve rotor walls of the plurality of valve rotor walls included in the valve rotor configured to engage the cam ramps on the valve housing as the valve rotor rotates about the valve axis to the plurality of different predetermined positions.

19. The multi-way valve of claim 18, wherein the sealing system further includes a seal located axially between the valve rotor and the valve housing.

20. A multi-way valve comprising
a valve housing coupled to a manifold of thermal fluid circuits, the valve housing including a valve housing body and a housing end cover coupled to a first end of the valve housing body, the valve housing body shaped to define a valve cavity and a plurality of apertures that open into the valve cavity, and the housing end cover coupled to the first end of the valve housing to close an end opening to the valve cavity, and
a valve flow controller includes a valve rotor arranged in the valve cavity of the valve housing body and configured to rotate relative to the valve housing body about a valve axis and an actuator coupled to the valve rotor to drive rotation of the valve rotor about the valve axis, the valve rotor includes a valve rotor plate, a plurality of valve rotor walls that extend axially away from the valve rotor plate and spaced apart circumferentially to define a plurality of valve ports, and a valve shaft that extends axially from the valve rotor plate through the housing end cover of the valve housing to a terminal end located outside the housing end cover and coupled to the actuator,
wherein the valve rotor cooperates with the valve housing to define a plurality of flow paths when the valve rotor is rotated about the valve axis to a plurality of different predetermined positions to control a flow of fluid through the valve housing.

21. The multi-way valve of claim 20, wherein the valve rotor plate is formed to include a rotor through hole that extends axially through the valve rotor relative to the valve axis so that the flow of fluid is able to flow axially through the valve rotor parallel to the valve axis.

22. The multi-way valve of claim 21, wherein the rotor through hole extend circumferentially partway about the valve axis.

23. The multi-way valve of claim 22, wherein the valve housing body includes an annular outer wall that extends around the valve axis to define the valve cavity, a housing base that extends from the annular outer wall and formed to define the plurality of apertures that extend radially through the housing base relative to the valve axis, and an end wall opposite the housing end cover formed to include an inlet aperture that extends axially through the end wall and opens into the valve cavity.

24. The multi-way valve of claim 23, wherein the inlet aperture extends circumferentially partway about the valve axis.
